(19) United States
(12) Patent Application Publication
(10) Pub. No.: US 2006/0123476 A1
(43) Pub. Date: Jun. 8, 2006

(54) System and method for warranting electronic mail using a hybrid public key encryption scheme

(76) Inventor: Karim Yaghmour, Rock Forest (CA)

Correspondence Address: JACOBSON HOLMAN PLLC, 400 SEVENTH STREET N.W., SUITE 600, WASHINGTON, DC, 20004, US

(21) Appl. No.: 10/547,418

(22) PCT Filed: Feb. 11, 2005
(86) PCT No.: PCT/CA05/00173

§ 371 Date: Nov. 29, 2005

(30) Foreign Application Priority Data
Feb. 12, 2004 (CA) 2,457,478

(51) Int. Cl. G06F 12/14

(52) U.S. Cl. 726/22

(57) ABSTRACT

The present invention provides a method and system for warranting electronic mail using a hybrid public key encryption scheme. In one embodiment, the sender contacts an authentication server which first identifies the sender as being allowed to send through the server, and secondly signs his email using a private key in order to send to the recipient. Upon receipt, the recipient can then verify that the sender is indeed authenticated by the authentication server by contacting the authentication server, requesting the sender's public key and using this public key to validate the signature contained in the email. It is possible that the authentication server may itself send the email to the existing mail servers, or it may simply return the signature to the sender for sending to the recipient along with the original email using the sender's existing outgoing email server.

### FIELD OF THE INVENTION

The present invention relates generally to electronic mail messaging. More particularly, it relates to a system and method for warranting an email between a sender and a recipient, using public key encryption signatures.

### BACKGROUND

Electronic mail (email) has become a primary means of communication for a large number of organizations, businesses and individuals. Its simplicity, efficiency, and, most importantly, its virtually inexistent cost have made it very popular. These same advantages, however, have become a problem for email users all around the world because they are being abused by what is commonly referred to as “spammers” to send a very large amount of unsolicited illegitimate email at virtually no cost to the sender.

There exist already quite a few proposed solutions to the “spam” problem. The following are the main solutions currently being promoted:
Filtering: In this case, a list generated by the user or a set of rules inferred using mathematical algorithms is used to classify email received by a recipient. Whitelists, blacklists, and Bayesian filters are examples of such filtering. While such techniques can be useful on the short-term, they are impractical for long-term email exchanges because they lead to an arms-race with spammers and often result in either false-positives (legitimate email being dropped) or false-negatives (illegitimate email being accepted.) While such solutions are increasingly being adopted, they are only a stopgap measure, and an increasing number of spammers are now capable of bypassing filtering mechanisms.
Challenge-response: In this case, a recipient (or the mail-reading software he uses), upon receiving an email from an unknown sender, generates and sends a challenge to said sender. The challenge is made to be difficult to respond to for automated responders, but easy to respond to for a human. Once the sender replies to the challenge, he is added to the recipient's list of valid senders. While this system may indeed result in less spam in the recipient's inbox, it puts a burden on the sender which is considered by many to be counter-intuitive. This solution has therefore not been widely adopted.
Signing: In this case, a sender has to sign his email using some form of encryption method. The recipient can then verify the sender's identity and, therefore, the email's authenticity by matching the signature with a known cryptographic identity of the sender. The problem with existing implementations of this scheme is that they require far too much understanding of cryptographic mechanisms on the part of the recipient and the sender. In addition, there have not yet been any proposed solutions to provide a scalable cryptographic identity exchange mechanism. This solution has therefore not been widely adopted.
Escrow and bond: In this case, the sender has to place a certain amount of money in escrow or provide bond in order to send email to his recipient. In turn, the recipient can collect the money if he feels or can show that the sender has sent an illegitimate email. Apart from scalability issues, the main problem with this scheme is that it assumes that recipients will act in good faith, which cannot be guaranteed. This solution has therefore not been widely adopted.
Stamps: In this case, the sender must pay for a stamp in order to send an email. Instead of money, a stamp may also require some CPU-intensive computation instead, or some other operation requiring some effort on the part of the sender. Either way, this scheme makes it easy for senders who send few emails, but makes it very costly for those sending spam. The problem with this scheme is that it requires substantial changes to existing infrastructures in order to either collect money or verify the CPU computation. This solution has therefore not been widely adopted.

Changes to server software: In this case, the software on the email server is modified in order to implement a new email authentication scheme. Such authentication may require providing a list of known users so that remote servers can verify identities with the original server, or may provide some form of cryptographic signing from the originating server. Such schemes, and their variations, require changing a substantial number of email servers around the world and are therefore impractical. This solution has therefore not been widely adopted.

Trademark signature: In this case, senders can use a trademark in their headers to warrant that their email is free of spam, and the trademark owner warrants that he will prosecute any party making improper use of his trademark. The problem with this scheme is that it assumes that the number of offenders is rather small or located in a geographic location where the law permits such prosecution. In practice, however, these assumptions do not hold, and such signatures have in fact now become an almost sure sign of spam. This solution has therefore not been widely adopted.

There are also other existing and proposed solutions, including combinations of the above-described schemes. However, none has yet succeeded in providing a viable solution to spam.

U.S. Patent Application published under no 2004/0024823 (Del Monte) describes a method whereby incoming emails are intercepted prior to reaching the intended recipient's SMTP server and are verified by an authenticating server in order to determine whether they are junk/spam and therefore discard them. While DEL MONTE is correct in claiming that a radical modification to the existing email system to solve the spam problem is unwieldy or impossible and provides examples of existing solutions that fail in this regard, his proposed solution is itself subject to a number of limitations and problems. First, by placing the authenticating server between the network from which the email is received and the original SMTP server, network management is made more difficult for the administrators taking care of this infrastructure as any awkward symptoms of the SMTP server's behaviour will require analysis of the authenticating server's behaviour and its interaction with the rest of the network components. Furthermore, authentication policies applied at the authenticating server are akin to “whitelisting”, which consist of a user establishing a list of users from which they are willing to accept emails from, and are known to be impractical because of the problems faced by senders to contact recipient which have yet to place them in their “whitelist”. It should also be mentioned that “whitelisting” is a technique that is often easily circumvented given that there is often no way to verify whether the fields in the email headers have been forged or not.

U.S. Patent Application published under no 2004/0134690 (Norris et al.) describes a method by which the identity of a mailpiece sender can be verified as being trusted. The method relies on the sender submitting biometric data related to his signature at the time of registration and this information being stored in a database. When signing with a digital pen for a mailpiece he is sending, the sender's biometric data is compared to the one already found in the database. If the data matches, registrant data is loaded onto the storage device on the mailpiece and may be digitally signed and/or encrypted by the trusted third party managing the database. Upon receiving the package, the postal service or carrier verifies that the sender is indeed trusted, the sender is billed (if necessary) and the package sent to the recipient. In another suggested embodiment, the recipient's email address is requested from the sender and the recipient is contacted by the carrier to verify whether they accept delivery of this package.

First and foremost, this application pertains to physical mailpieces and does not attempt to claim that the process described may, in any way, be applied to email. Even if it were accepted, for the purpose of argument, that patents pertaining to physical mail may be applied to email, it remains that the process described by this patent application may not be effective to solve the spam problem (it should be noted that NORRIS et al. do not attempt to solve the physical junk mail issue, as is discussed below). For one thing, the carrier, which may figuratively be identified as being the network, and by extension the recipient's mail server, is responsible for identifying forged or unstrusted incoming mail. As is argued in DEL MONTE, modifications to existing email network infrastructure is highly problematic because of the number of existing email servers and impractical because of the work required by system administrators to manage such a major change to their existing infrastructure.

Not to mention that the problem this method attempts to solve is that of physical mail senders sending packages which may be dangerous to recipients; specifically in reaction to the 2001 Anthrax letters incidents. It does not attempt to address the issue of preventing senders from sending unwanted or junk physical mail.

U.S. Patent Application published under no 2004/0003255 (Apyrille et al.) describes a system where the outgoing mail server includes a dedicated hardware card that is responsible for digesting an incoming email, appending a date and time to the digest to create a timestamp, and signing the result with a private digital signature. Thus, the outgoing mail contains a stamp that is resilient to falsification and tampering by the sender and can therefore be verified by the recipient. Specifically, this method pertains to solving the problem of email timestamps being universally unreliable. Though the issue of digitally signing emails is discussed, this method does not attempt nor does it claim to help solve the spam problem. Even if it were used for that purpose, it would suffer from the same problems that other spam solutions where the outgoing mail server is modified suffer from. Mainly such solutions are unlikely to be widely adopted given the existing number of mail servers and the work that may be required by system administrators through the world to change all the mail servers they manage. Furthermore, the private key used to sign emails is universal to all senders. Consequently, each sender is limited to have only one (1) cryptographic identity.

U.S. Patent Application published under no 2002/0181703 (Logan et al.) describes a method whereby a sender obtains a public key—private key pair that is signed by a Certification Authority (CA). This pair of keys is signed by the CA in exchange for a pledge by the sender that he will follow a set of guidelines (“good conduct” rules) for emails signed using the private key. When sending an email, the sender must attach a pledge to his email and an indication of the number of similar emails the sender has sent to other recipients, and then signing the email with his private key and sending it off to the recipient. Upon receiving the mail, the recipient retrieves the sender's public key from the CA and verifies that the email indeed originated from the sender and was signed by a private key that was itself signed by the CA.

In this proposed solution, the sender has to manage his own cryptographic identity (for example, he must notify the CA if his private key has been compromised). One drawback with this proposed solution is that the concept of public/private key may not be as widespread or as intuitive to understand as, say, that of a username and a password. The solution proposed by LOGAN et al. therefore poses an adoption problem that hinges on the ability of its promoters to educate the majority of computer users as to the mechanics and the responsibilities involved in using a public/private key infrastructure.

Also, the CA signs sender's keys only once at sign-up, and there is therefore no run-time verification possible by the CA as to the type and quantity of emails being sent by the sender. In addition, there is no way for the CA to monitor whether the sender's system is compromised or not. There is also no way for the CA to limit the number of emails being sent by the sender. So while an abusing sender may eventually be caught in LOGAN et al.'s proposed solution, there may be no mechanism for identifying abusing senders in as short a time as possible or in an automated fashion.

There is thus a need for an email authentication system and method that are much simpler for the end user and wherein the user does not need to be taught a new concept. At most, the user may need to know the username and password for his account with an authenticating server, and, as stated above, usernames and passwords are a concept that is trivial for new users to grasp and is already quite well understood by the majority of existing computer users which probably already need to know their username and password to log into their computer and/or have an email account which requires a username and password to receive and/or send email.

U.S. Patent Application published under no 2002/0059454 (Barret et al.) describes a system whereby electronic data sent by a sender is intercepted at an intermediary located between the sender and the intended recipient of the electronic data. The sender may then be identified at the intermediary and the electronic data may be modified to reflect the information identifying the sender, the changed data thereafter being sent to the intended recipient.

Given that the sender identification is conducted at an intermediary between the sender and the recipient, BARRET et al.'s method requires a modification to the existing email infrastructure. Like other spam solutions that require modification to existing email infrastructure, and as argued by DEL MONTE, the large-scale deployment and adoption of this method is problematic. In addition, BARRET et al. suggest that sender identification be based on the sender's address. However, any such scheme where the sender is not required to take part in an authentication process with a signing authority leaves the door open to abuse.

Moreover, BARRET et al. stipulate that the information added at the intermediary “renders the identity of the sender immediately recognizable to the designated recipient.” However, without a means of checking with a third party, no such immediate recognition may be truly trusted by a recipient.

Also, as in the case of APVRILLE et al., the sender has no options as to whether his outgoing messages are modified to authoritatively identify him or not. So, as mentioned earlier, each sender being limited to only one (1) cryptographic identity, the sender cannot send traffic which does not conform to the established rules of the signing authority. Not to mention that in BARRET et al., the sender does not have control over (and therefore cannot be held personally responsible by the recipient for) the exact metadata or modifications made to his email.

There is thus a need for an email authentication system and method in which the existing mail server infrastructure remains unchanged, and would therefore not be impacted by the use of such a system and method by the existing users.

There is also a need for such a system and method in which there would be no special requirements for initiating contact with recipients which are not aware of the sender, haven't seen his address before, or haven't been contacted by the sender prior to the initiating contact.

### SUMMARY OF THE INVENTION

An object of the present invention is to provide an email authentication system and method that overcome at least one of the previously listed drawbacks and that satisfy at least one of the above-mentioned needs.

Another object of the present invention is to provide an email authentication system and method preventing forgery of emails by using public/private keys cryptography to sign emails.

Another object of the present invention is to provide an email authentication system and method that require no or minimum changes to an existing email infrastructure.

Another object of the present invention is to provide an email authentication system and method warranting that senders' correspondence gets preferential treatment from the recipient.

Still, another object of the present invention is to provide an email authentication system and method comprising an authentication server signing every single outgoing email one by one, so that it can randomly or systematically check in an automated fashion whether a sender's outgoing mail meets some basic criteria of what can be categorized as spam.

A further object of the present invention is to provide an email authentication server notifying those who manage it of certain conditions so that they, in turn, help avoid that the sender's identity being stolen and notify him that his system may have been potentially compromised (a process which may also be automated to a certain extent).

Another object of the present invention is to provide an authentication server that is an independent entity which the sender can optionally choose to interact with if he wants to get his email signed, the rest of the email transaction being carried out exactly as it was prior to the authentication server being introduced.

Another object of the present invention is to provide an email authentication system and method in which a sender of an email has an account with an authentication server and has thereafter to authenticate himself with the authentication server prior to being permitted to get every single email signed.

Another object of the present invention is to provide an email authentication system in which a recipient of a signed email has to retrieve the sender's public key from a database and can thenafter verify that the sender's email was indeed signed by the proper private key. The authentication system therefore acts as the third party with which the recipient can verify the sender's identity.

According to the present invention, there is provided a system for authenticating an email from a sender station to a recipient station via a mail server, comprising:

a database separate from the sender station, for storage of sender-related data, the sender-related data comprising a public key and a private key for each sender, the private key being kept inaccessible to each sender;

a signing module separate from the sender station and connectable to the database, for producing a signature for an email in response to an email signing request, the signature being produced as a function of the private key found in the database in association with a sender;

a combining module connectable to the signing module, for sending a signed email to the recipient station via the mail server, the signed email resulting from a combining of the signature with the email;

a public key module connectable to the recipient station and the database, for returning the public key found in the database in association with a sender in response to a public key request;

a sender module integrated in the sender station and connectable to the signing module, for generating the email signing request prior to transmission of the email to the recipient station; and

a recipient module associated with the recipient station and connectable to the public key module, for generating the public key request triggered at reception of the signed email, and validating the signature of the signed email with the public key returned by the public key module.

According to the present invention, there is also provided a method for authenticating an email from a sender station to a recipient station via a mail server, comprising the steps of:

a) storing sender-related data separately from the sender station, the sender-related data comprising a public key and a private key for each sender, the private key being kept inaccessible to each sender;

b) generating an email signing request from the sender station and prior to transmission of an email to the recipient station;

c) producing a signature separately from the sender station, for the email in response to the email signing request, the signature being produced as a function of the private key found in the sender-related data in association with the sender;

d) sending a signed email to the recipient station via the mail server, the signed email resulting from a combining of the signature with the email;

e) generating a public key request triggered at reception of the signed email;

f) returning the public key found in the sender-related data in association with the sender, in response to the public key request; and

g) validating the signature of the signed email with the returned public key.

Preferably, the sender module contacts the authentication server which first identifies the sender as being allowed to send through the server, and secondly signs the email as a function of the private key of the sender. Upon receipt of the signed email, the recipient can then verify that the sender is indeed authenticated by contacting the authentication server, requesting the sender's public key and using this public key to validate the signature contained in the email. It is possible that the authentication server may send the signed email to the existing mail servers, or it may simply return the signature to the sender for sending the signature with the original email using the sender's existing outgoing email server.

Preferably, although the sender does not have access to his private key, he may be provided with an account, possibly for a fee, to log in to the authentication server and have his emails signed. This is an important departure from existing solutions as the sender doesn't have full control over his cryptographic identity, yet the validation of his email does not require any changes on any of the servers involved either on the sender's end or the recipient's end. Rather, the signing process on the sender's end and the validation process on the recipient's end are carried out transparently by their respective email clients (software used to read, write, send, and receive email), possibly using a plug-in.

Preferably, in case of abuse, the authentication server may identify the offending sender by verifying the signature provided by the receiver reporting the offence. Action may then be taken on the sender's account, possibly imposing a fine, or barring the sender from further sending to the recipient.

Preferably, the email authentication system comprises:
the authentication server which authenticates the sender, signs the emails, provides public keys to 3^{rd} parties such as recipients, and verifies the identity of offenders;
the software used by the sender and recipient to communicate with the authentication server in order to sign or validate email; and
all additional software and hardware required to implement the system.

Preferably, with the present email authentication system and method, the sender has some control over his metadata and content.

### BRIEF DESCRIPTION OF THE DRAWINGS

A detailed description of preferred embodiments will be given herein below with reference to the following drawings, in which like numbers refer to like elements:

FIG. 1 is a block diagram showing an embodiment of an email authentication system according to the present invention, wherein the sender mail server and the recipient mail server are the same servers.

FIG. 2 is a block diagram showing another embodiment of an email authentication system according to the present invention, wherein the sender mail server and the recipient mail server are separate servers.

FIG. 3 is a simplified block diagram of an email authentication system according to the present invention.

FIG. 4 is a block diagram showing another embodiment of an email authentication system according to the present invention, wherein the signed email is sent to the recipient station from the authentication server.

FIG. 5 is a block diagram showing another embodiment of an email authentication system according to the present invention, wherein the database and the public key module are separate from the authentication server.

FIG. 6 is a block diagram showing another embodiment of an email authentication system according to the present invention, wherein the recipient module is integrated in the recipient mail server.

FIG. 7 is a block diagram showing portions of an email authentication system, for carrying out the authentication and signature of the sender's emails.

FIG. 8 is a block diagram showing portions of an email authentication system, for carrying out the delivery of the sender's public key to the recipient.

FIG. 9 is a block diagram showing one possible embodiment of the registration process for new senders.

### DETAILED DESCRIPTION OF PREFERRED EMBODIMENTS

It is worth noting that in FIGS. 1 to 9, dotted boxes are used for optional components which may or may not be used, or may be replaced with other components altogether. New components may also be added. Dotted arrows indicate a set of possibilities.

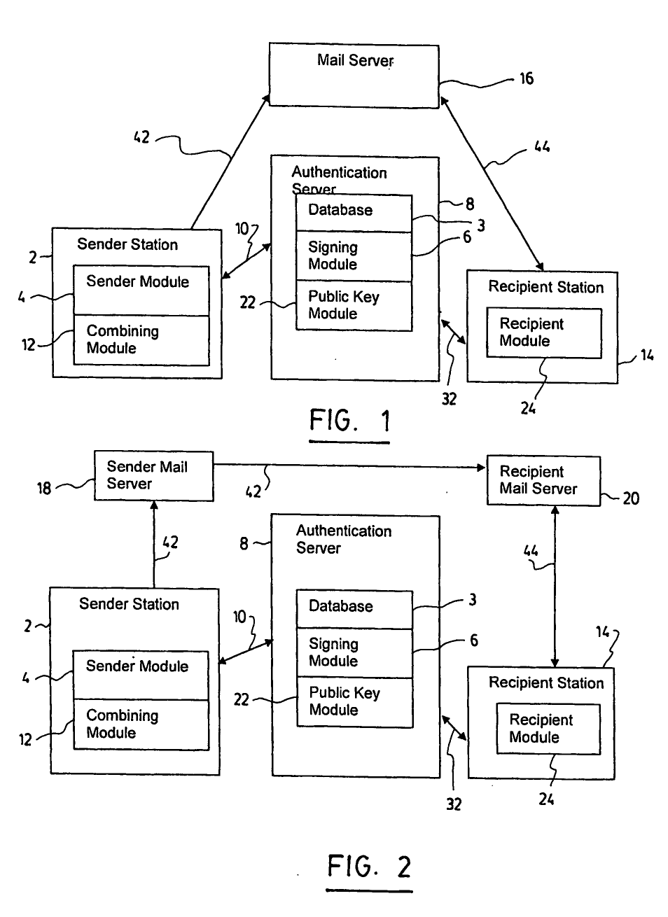

Referring to FIGS. 1 and 2, the email authentication system of the present invention authenticates emails (headers, text body, attachment(s), etc.) between a sender station 2 and a recipient station 14 via a mail server 16. In FIG. 1, a sender mail server and a recipient mail server are the same mail server 16, while in FIG. 2, the sender mail server 18 and the recipient mail server 20 are separate from each other.

The system comprises a database 3 separate from the sender station 2, for storage of sender-related data. The sender related data comprises a public key and a private key for each sender. The private key is kept inaccessible to each sender. Therefore, the sender does not know his private key. The sender station 2 may be a typical desktop workstation, a server, or any other suitable device from which an email can be sent. The sender station 2 can run any operating system (ex.: Windows®, MacOS®, Linux®, etc.) and any email client application typically used to retrieve/read/send email (e.g. Eudora®, Outlook®, Outlook Express®, Netscape®, etc.).

A sender module 4, such as an email client plug-in, is integrated in the sender station 2 and interfaces with the sender's existing email client application. Other configurations may also be possible, with the use of other software than an email client plug-in. For example, the sender module 4 may be an email application on its own. The sender module 4 is activated when the sender attempts to send an email that is to be signed to the recipient station 14. The sender module 4 generates an email signing request (as depicted by arrow 10), prior to transmission of the email to the recipient station 14.

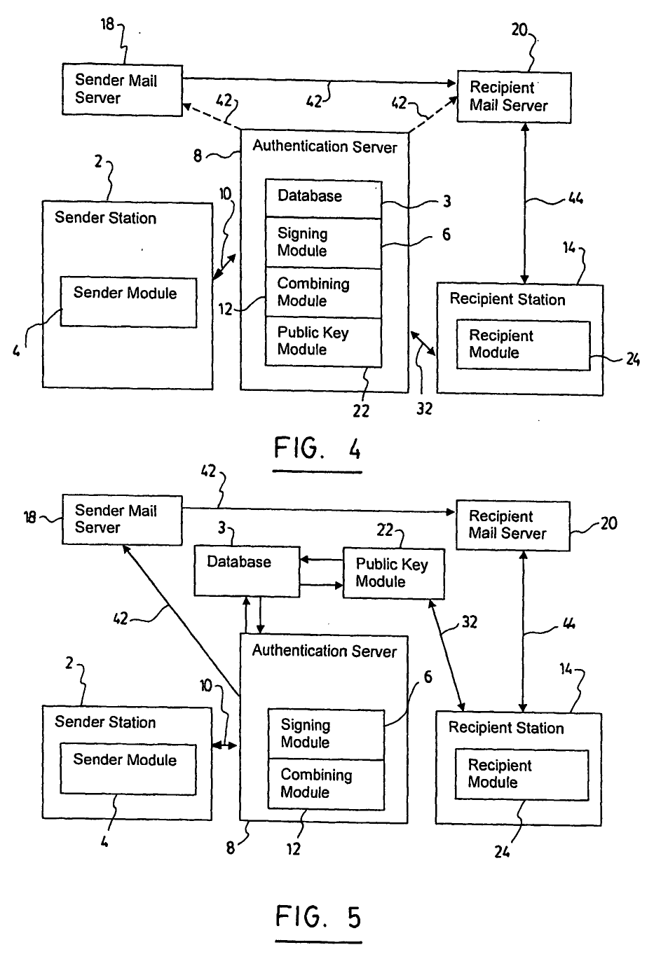

A signing module 6 separate from the sender station 2 and connectable to the database 3, receives the email signing request 10. The signing module may be integrated in an authentication server 8. Therefore, the sender module 4 contacts the authentication server 8 and conducts proper client identification handshake routine with the authentication server 8, and, having been successfully identified as a legitimate sender, the sender module 4 sends the email to be signed to the authentication server 8. As will be later described, the sender module 4 may then receive a signature from the authentication server 8. A combining module 12 connectable to the signing module 6 then combines the signature to the outgoing email, thereby obtaining a signed email, and lets the signed email be sent as it may usually through the existing mail servers (SMTP servers). The combining module 12 may be integrated in the sender station or in the authentication server 8 (shown in FIG. 4).

In the case where the outgoing SMTP server configured in the sender's email application is the authentication server 8 instead of being the existing sender mail server 18, a send request for an email (e.g. when the sender presses a send button of the email application) may automatically generate the email signing request 10. Therefore, the email signing request 10 may be the transmission of the email to the authentication server 8. For example, authentication of the sender with the authentication server 8 may be provided based on existing authentication methods between the sender and the sender's original mail server.

As previously mentioned, the authentication server 8 is connectable to the sender station 2. The authentication server 8 is typically a server, a series of servers or a network with a complex server configuration running a robust and secure operating system, or a network configuration of such operating systems, capable of handling high network traffic (e.g. Linux®, Solaris®, AIX®, etc.).

The signing module 6 receives the email signing request 10 from the sender module 4. The authentication server 8 conducts the appropriate identification handshake in order to identify that the sender has the right to have his email signed, and, once this is determined to be true, the signing module 6 retrieves the sender's private key, produces a signature as a function of the private key found in the database 3 in association with the sender, and returns the signature to the combining module 12. The combining module 12 combines the signature with the email and then sends the signed email to the recipient station 14 via the sender mail server 18. The sender mail server 18 is likely to remain unchanged by the integration of the authentication system. The sender mail server 18 receives a send request from the sender station 2 and conducts the proper handshaking for sending the signed email to the recipient mail server 20, e.g. a recipient SMTP server. The authentication server 8 may also conduct a number of other functions, such as controlling the number of emails sent by a sender within a given time-frame. The authentication server 8 may be embodied in a network server publicly accessible on the Internet or it can be embodied in a network appliance that resides on an organization's private network for the purpose of signing emails. There is also the possibility that the authentication server 8 may act as an SMTP server and therefore forward the signed email to the existing SMTP mail servers.

The recipient mail server 20 is the recipient's existing SMTP server. The recipient mail server 20 may remain unchanged by the integration of the authentication system. The recipient mail server 20 is typically contacted by the sender's SMTP server 18 or the authentication server 8, receives the signed email, stores the signed email for the recipient to retrieve, conducts the proper handshaking for allowing the recipient to retrieve any emails received for him, and retrieves the emails stored for a recipient, when requested by the recipient, and transfers them to the recipient's email client software.

The recipient station 14 may be a typical desktop workstation, a server or any other suitable device for retrieving email from a mail server. The recipient station 14 may run any operating system (e.g.: Windows®, MacOS®, Linux®, etc.) and any email client application typically used to retrieve/read/write/send email (e.g.: Eudora®, Outlook®, Outlook Express®, Netscape®, etc.).

A recipient module 24 is associated with the recipient station 14. The recipient module 24 may be an email client plug-in interfacing with the recipient's existing email client application. The recipient module 24, which may be the same plug-in used for contacting the authentication server 8 and getting emails signed as described earlier, is activated when an email is received by the recipient as part of the normal email retrieval. At such a time, the recipient module 24 verifies whether the email contains a signature from the authentication server 8. The recipient module 24 generates a public key request 32 triggered at reception of the signed email to retrieve the sender's public key. Upon reception of the public key, the recipient module 24 validates the signature of the signed email, and marks the email accordingly for the recipient to see. For example, if the email does contain a valid signature, the email may be highlighted as part of the list of emails contained in the recipient's Inbox. Other configurations are possible, with the use of other software than an email client plug-in. For example, a proxy daemon may filter out emails which don't contain signatures or contain invalid signatures so that the recipient may not even see them in his Inbox.

A public key module 22 is connectable to the recipient station 14 and the database 3. The public key module 22 receives the public key request from the recipient module 24 for retrieving the public key from the database 3 in association with the sender. The public key module 22 looks up the requested public key, retrieves it, and, if it is found, returns it to the recipient module 24. The public key module 22 may be a server separate from the authentication server 8, with possibly a different network address and/or a different physical location, or it can be seen from the outside as having the same network address, or be hosted on the same hardware, as the authentication server 8. Its location, visibility, and possible aggregation with another system component may not change its role or behaviour.

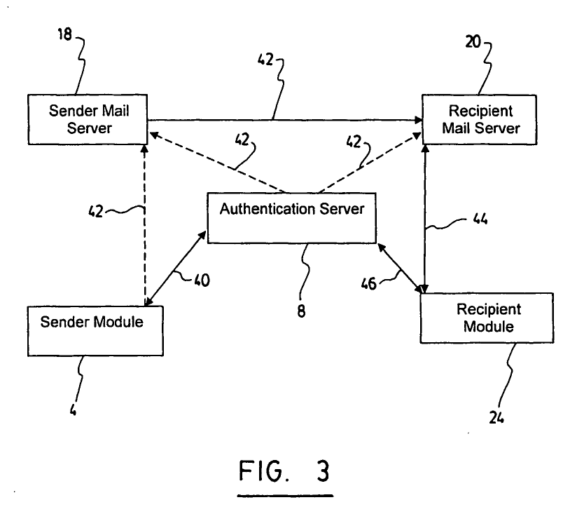

The present system places the burden of certifying the legitimacy of email on the sender. Referring now to FIG. 3, the sender module 2 has his email signed by the signing module (not shown) on the authentication server 8 using the sender-specific private key prior to it being delivered to the recipient (arrow 40). The signed email is then delivered to the recipient mail server 20 (arrows 42) either through the authentication server 8 itself or using the sender mail server 18. After the signed email is extracted from the recipient mail server 20 (arrow 44), the recipient module 24 contacts the public key module 22 (not shown) on the authentication server 8 (arrow 46) and requests the sender's public key. The recipient module 24 may also cache already obtained public keys for future use. Using the sender's public key, the recipient module 24 can verify that the email was indeed sent by the sender. While the sender may be required to have an account on the authentication server 8, the recipient is not required to have such an account, though having an account on the authentication server 8 may provide recipients with advantages; blacklisting senders and enabling end-to-end encrypted exchanges being two such examples.

In addition to FIGS. 1 and 2, FIGS. 4 to 6 illustrate other possible embodiments of email authentication systems according to the present invention. Of course, other embodiments may also be considered. For example, the authentication server 8 may be a single physical machine, but may also be a set of independent physical machines instead.

FIG. 4 shows the combining module 12 integrated in the authentication server 8 and sending the signed email to the sender mail server 18 or the recipient mail server 20.

In FIG. 5, the database 3 and the public key module 22 are separate from the authentication server 8.

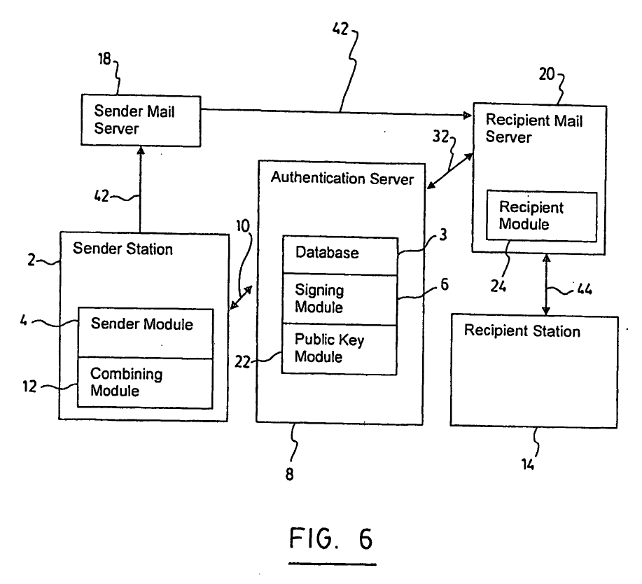

In FIG. 6, the recipient module 24 is integrated in the recipient mail server 20.

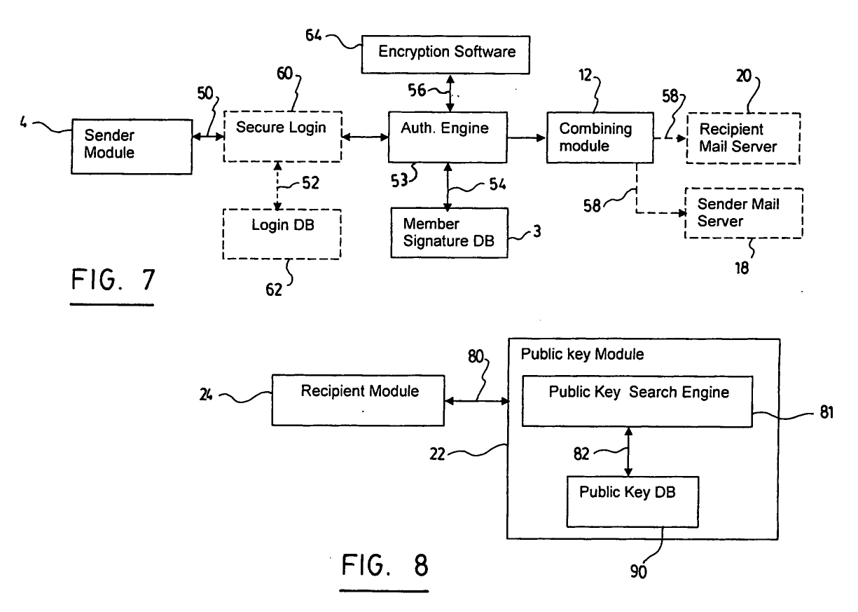

As shown in FIG. 7, the sender may log in to the authentication server 8 using the OpenSSH remote login suite (arrow 50). The signing module may comprise an authentication engine 53 along with other modules for that purpose. In that case, there may be a database 62 to validate logins (arrow 52). OpenSSH is useful for: a) verifying that the sender indeed has access to the authentication server's services, b) securing the exchange between the authentication server 8 and the sender module 4, c) allowing communication between the sender module 4 and the authentication server 8 even if the sender's ISP is filtering the SMTP port. It is possible, however, to provide these capabilities using other software combinations. Using SSL with an HTTP connection is such an example. In fact, it is possible to tunnel all communication between the sender module 4 and the authentication server 8 over HTTP in the case where this is the only service that is not filtered by the sender's ISP. A custom-built connection mechanism may also be used. Once the connection is established, the authentication engine 53 may then retrieve the sender's private key from the database 3 (arrow 54). Using this private key, the authentication server 8 may then feed the message and the private key to the signing module 6, which may be an encryption software 64 (arrow 56) such as GPG.

To avoid sending large attachments for signing by the authentication server 8, the sender may instead send the hash checksum of the attachments and the email text body, which may then be both signed by the authentication server 8. The signed email, resulting from running the encryption software on the data provided by the sender, may then either be delivered to the recipient mail server 20 (arrow 58) via existing mail servers using traditional mail services packages, such as Sendmail, or only the generated signature may then be provided back to the sender for him to send using his existing email servers, as explained earlier. Regardless of the actual delivery mechanism being used, the signature may be customized for the purposes of the system's architecture. The list of recipients and a few other mail headers, for example, may also be part of the signature in order to avoid false reports of illegitimate emails (i.e. Recipients claiming they received an email when in fact they had stolen it and counterfeited its headers to file a false complaint against the sender).

There are, of course, a number of variations and features that can be implemented in this system. If the recipient is also a member (has an account in the system) he may be allowed to blacklist senders, either by personal choice or following the receiving of what the recipient considers illegitimate email. In this case the authentication server 8 may check the sender's recipients and refuse to sign emails destined to recipients who blacklisted the sender. Instead of GnuPG, other public key cryptographic software may also be used, such as PGP, or a cryptography suite may be developed custom for this invention. In order to avoid attracting potential brute-force breaking of keys by spammers wanting to abuse this scheme, the authentication server 8 may use keys that have expiry dates instead of keys that never expire. The size of the cryptographic keys and their duration will have to be chosen in function of the computational capabilities available at that period in time. Over time, the size of the keys may have to increase and/or their duration may have to shorten in order to keep the degree of difficulty of breaking the keys high enough that abusers will not be successful in breaking the system. The use of random expiration dates (opaque to the users), may also be considered.

Also, it may be possible to implement a rating system such as those already existing on many web sites (ex.: amazon.com, ebay.com, etc.) to rate senders. Hence, recipients may be allowed to judge senders on the content they send. The software used by the recipients to talk to the authentication server may then query the server for the rating of the sender. Using this information, the recipient's software may then choose to either apply filtering to the received message or display messages differently according to the rating of the sender.

The database 3 may contain the following information pieces for each sender:
Membership ID;
email addresses (a single member may decide to service more than one address through a single membership); and
Private and public keys.

Other information fields relevant to the signing of senders' emails may be added. For example, a field may be added for listing the recipients from which this sender is blacklisted from sending to. It is also worth noting that the public key may instead be stored in another database.

Upon receiving a signed message, the recipient module 24 may: 1) recognize the signed message; 2) retrieve the sender's public key from the public key module 22; 3) verify the email signature using the public key, the signature and the appropriate public key cryptography software. All recipients, whether they have an account on the authentication server 8 or not, are allowed to retrieve senders' public keys. By having an account with the authentication server 8, the recipient may also be allowed to create blacklists of users from which he desires not to receive any mail from. This may involve having a database that takes care of blacklisting, or it may involve implementing blacklisting in the software provided to the recipient. In addition to blacklisting, the recipient may be able to instruct the authentication server 8 to hold messages from certain senders for a certain amount of time, in the case where it's the authentication 8 server that sends the messages to the recipient's mail server 20, for example. It can also be possible for the recipient mail server 20 of the recipient to verify the mail signature by automatically completing steps 1) to 3) listed above (as shown in FIG. 6).

FIG. 8 illustrates the system's possible architecture of the public key module 22 for dealing with requests for public keys from the recipient. The recipient module 24 communicates with the public key search engine 81 (arrow 80), and the latter communicates with a public key database 90 (arrow 82) to retrieve the public key the recipient is asking for. The public key database may be the same database 3 storing the private keys.

If the recipient is not equipped with the appropriate software to communicate with the authentication server 8, the sender's email should still be humanly readable. In essence, the sender's email should appear as a GPG signed mail, or an email with an extra attachment containing the signature, depending on how the invention is implemented.

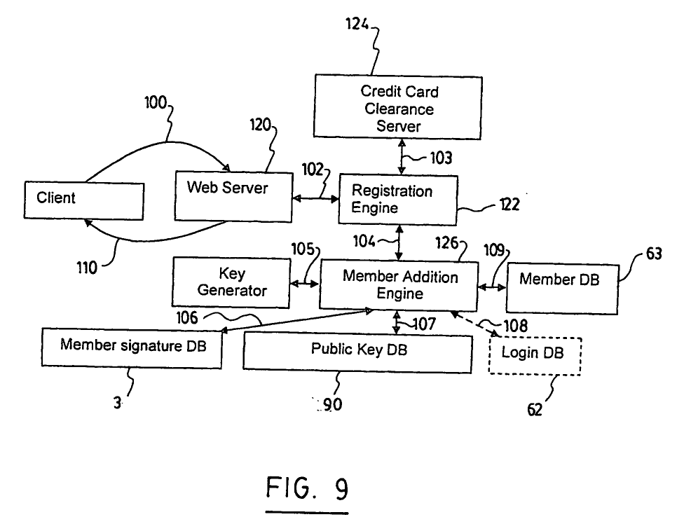

FIG. 9 illustrates a possible architecture for implementing the registration of a new sender (new member) to the system. Typically, the new member may use his web browser to connect to a secure web site (possibly Apache with OpenSSL) and fill-in the required fields for creating a new account (arrow 100), such as name, address, credit-card number, etc. The web server 120 then provides this information to a registration engine 122 (arrow 102) which then verifies the member's information and contacts the credit-card clearance server 124 (arrow 103) to validate the credit card information provided by the user. Once this is successful, the registration engine 122 gives control to the member addition engine 126 (arrow 104) which carries out a number of tasks to finalize the member's registration. Typically, this may involve: 1) creating a pair of private and public keys for the new member (arrow 105), 2) providing the private key to the member signature database 3 (arrow 106), 3) providing the public key to the public key database 90 (arrow 107), 4) adding the new user to the login database 62 (arrow 108) so that the member may be able to log in and get email signed, and 5) create a new entry for the user in the member database 63 (arrow 109). The member database 63 may contain the following entries for each member:
Private membership ID (numeric ID used internally)
Public membership ID (alphanumeric ID used for the user to log in)
Encrypted credit card number
Contact information
User preferences

More fields may also be added. For example, members may be allowed to use a web interface to subscribe/unsubscribe from “official” vendor newsletters. This may easily be extended to provide users with an easy to use digital identity management system. Once the user has been added to the member database, he is provided with a membership registration confirmation (arrow 110) which contains an alphanumeric user-id (possibly supplied by the user and validated to make sure it doesn't already exist) and a password for logging-in (also possibly supplied by the user and validated for length and complexity).

During the initial trial of the system, users may be allowed to become members for free in order to evaluate the system. As such, they may probably not be required to provide their credit-card information. Instead, they may be presented with a bar code image which they may have to print out and send back using traditional letter mail in order to confirm their registration. This process may discourage potential abusers from disrupting the system by creating a large number of illegitimate accounts. Also, the number of messages each sender is allowed to send may be limited to a certain number per hour, say one hundred (100). Hence, even if a member's system is compromised, it cannot be used to send unlimited amounts of email. This maximum may be maintained even for paying customers to act as a throttle. Members wanting to send more mail may possibly be required to pay an additional fee and/or justify their need. During the initial evaluation period of the implementation, it may be desirable to provide different qualities of certification. As such, the email from paying senders may be of “better” certification quality than that of email from senders participating in the system's free trial use. This may be visible to the recipient using a different highlighting color for the various email certification types, or using some other form of filtering. This system of providing different grades of certification may also be extended for the lifetime of the production implementation of this invention.

While this invention, as currently described, is unlikely to take care of the case where a member's system has been compromised and is used to send illegitimate email, leaving it to the member's responsibility to update his anti-virus software or pay the penalties for his system having sent illegitimate email, stop-gap measures and enhancements may be added in the future to reduce the impact of such breaches.

In addition to the basic functionality described above, there are a number of enhancements that can be added. It is possible, for example, for the authentication server 8 to act as a broker for end-to-end encrypted communication between the sender and the recipient, if both have an account on the authentication server 8. In that case, the members may likely have to create a private and public key pair on their systems when signing up for a membership on the authentication server 8, and provide their local public keys to the authentication server 8 for use by other members. Hence, the server may have two public keys in its database for each user, one for authenticating senders, and one for allowing members to securely exchange data. Said encrypted exchanges may also be signed by the authentication server.

In order to log complaints with the entity servicing the authentication server 8, the recipient of an illegitimate email may provide the servicing entity with a verbatim copy of the received mail including the signature and the mail headers (containing the sender's address.) The origin of the email may then be verified using the database 3, and appropriate action may be carried out, possibly following a yet to be defined user agreement. One possible outcome is the blacklisting of the sender by the recipient. As such, this may require adding the appropriate entries in the appropriate databases.

In addition, there may be appliance versions of the authentication server 8 implemented for providing to 3^{rd} parties for signing their own users' emails. For example, it may be desirable for companies like IBM® or Yahoo!® to have their own authentication server instead of relying on an external server. In such a case, they may be provided with network appliances implementing the above-described invention to sign their own users' email. These appliances may possibly implement a minimum level of synchronization with a central server and possibly provide interfaces for direct communication with other such appliances. Emails sent from such appliances may likely require two signatures, one for the user and one for the appliance. The user signatures may probably be used similarly as described earlier for a single authentication server. The appliance key may be used to hold the appliance's owning organization accountable for their use of the invention's privileges. Mass-mailings, for example, may likely be prohibited. In order to avoid abuse, the appliances are likely to be counter-fit proof and tamper-proof. Some sort of keepalive signal may be used to make sure appliances are on-line all the time. Some remote-login capability may also be relevant for ensuring the proper operation of the appliance. To properly deal with these appliances, the software used by the recipients may be made to properly handle multiple authentication servers. The authentication server ID may be included as part of the signature provided by the authentication server for the sender to send with his mail. Some authentication of the appliance may be carried out with a central authentication server. The appliance's public key, for example, may not be available from the appliance itself, but from a central authoritative authentication server.

Example synchronization between authentication appliances may be blacklisting. If joe@ibm.com is blacklisted by heather@sudo.org, then the appliance taking care of sudo.org, or the main authentication server if sudo.org doesn't have an appliance, may contact the appliance serving ibm.com and inform it to add a blacklist rule for heather@sudo.org in its database. This may involve having a database specifically taking care of blacklisting.

While embodiments of this invention have been illustrated in the accompanying drawings and described above, it will be evident to those skilled in the art that changes and modifications may be made therein without departing from the essence of this invention.

1. A system for authenticating an email from a sender station to a recipient station via a mail server, comprising:
a database separate from the sender station, for storage of sender-related data, the sender-related data comprising a public key and a private key for each sender, the private key being kept inaccessible to each sender;
a signing module separate from the sender station and connectable to the database, for producing a signature for an email in response to an email signing request, the signature being produced as a function of the private key found in the database in association with a sender;
a combining module connectable to the signing module, for sending a signed email to the recipient station via the mail server, the signed email resulting from a combining of the signature with the email;
a public key module connectable to the recipient station and the database, for returning the public key found in the database in association with a sender in response to a public key request;
a sender module integrated in the sender station and connectable to the signing module, for generating the email signing request prior to transmission of the email to the recipient station; and
a recipient module associated with the recipient station and connectable to the public key module, for generating the public key request triggered at reception of the signed email, and validating the signature of the signed email with the public key returned by the public key module.

2. The system according to claim 1, further comprising an authentication server separate from the mail server, and wherein the signing module and the combining module are integrated in the authentication server.

3. The system according to claim 1, further comprising an authentication server separate from the mail server, and wherein the combining module is integrated in the sender station and the signing module is integrated in the authentication server.

4. The system according to claim 1, further comprising:
an additional mail server, one of the mail servers being associated with the sender station and forming a sender mail server, the other one of the mail servers being associated with the recipient station and forming a recipient mail server; and
an authentication server separate from the sender mail server and the recipient mail server, the signing module being integrated in the authentication server.

5. The system according to claim 4, wherein the combining module is integrated in the sender station, the combining module having a function for sending the signed email to the recipient station via the sender mail server.

6. The system according to claim 4, wherein the combining module is integrated in the authentication server, the combining module having a function for sending the signed email to the sender mail server.

7. The system according to claim 4, wherein the combining module is integrated in the authentication server, the combining module having a function for sending the signed email to the recipient mail server.

8. The system according to claim 4, wherein the public key module is integrated in the authentication server.

9. The system according to claim 1, further comprising an authentication server separate from the mail server, the signing module being integrated in the authentication server, the email signing request comprising sender-related login data for login of the sender into the authentication server, the authentication server comprising a login module associated to the database, for validating the sender-related login data found in the database and granting the sender access to the signing module.

10. The system according to claim 1, wherein the email signing request comprises a text body of the email and a hash checksum of an attachment to the email, the signing module having a function for producing a signature for the text body of the email and a signature for the hash checksum of the attachment.

11. The system according to claim 4, wherein the recipient module is integrated in the recipient station.

12. The system according to claim 4, wherein the recipient module is integrated in the recipient mail server.

13. The system according to claim 1, further comprising a public key database integrated to the recipient module, for storing the public key returned by the public key module.

14. The system according to claim 1, further comprising a registration module connectable to the database, for registering an additional sender in the database, based on information provided by the sender following a sender registration process under control of the registration module.

15. The system according to claim 14, further comprising a key generator module connectable to the registration module, for generating a public key and a private key in association with the additional sender, the public key and the private key in association with the additional sender being stored in the database.

16. A method for authenticating an email from a sender station to a recipient station via a mail server, comprising the steps of:
a) storing sender-related data separately from the sender station, the sender-related data comprising a public key and a private key for each sender, the private key being kept inaccessible to each sender;
b) generating an email signing request from the sender station and prior to transmission of an email to the recipient station;
c) producing a signature separately from the sender station, for the email in response to the email signing request, the signature being produced as a function of the private key found in the sender-related data in association with the sender;
d) sending a signed email to the recipient station via the mail server, the signed email resulting from a combining of the signature with the email;
e) generating a public key request triggered at reception of the signed email;
f) returning the public key found in the sender-related data in association with the sender, in response to the public key request; and
g) validating the signature of the signed email with the returned public key.

17. The method according to claim 16, wherein step d) is performed at the sender station.

18. The method according to claim 16, wherein step c) and step d) are performed at an authentication server separate from the mail server.

19. The method according to claim 16, further comprising an additional mail server, one of the mail servers being associated with the sender station and forming a sender mail server, the other one of the mail servers being associated with the recipient station and forming a recipient mail server, and wherein step c) is performed at an authentication server separate from the sender mail server and the recipient mail server.

20. The method according to claim 19, wherein step d) is performed at the sender station, the mail server of step d) being the sender mail server.

21. The method according to claim 19, wherein step d) is performed at the authentication server, the mail server of step d) being the sender mail server.

22. The method according to claim 19, wherein step d) is performed at the authentication server, the mail server of step d) being the recipient mail server.

23. The method according to claim 19, comprising an additional step, before step c), of login of the sender into the authentication server.

24. The method according to claim 19, wherein step c) comprises signing a text body of the email and signing a hash checksum of an attachment to the email.

25. The method according to claim 19, wherein step e) is performed at the recipient station.

26. The method according to claim 19, wherein step e) is performed at the recipient mail server.
